(19) United States
(12) Patent Application Publication
(10) Pub. No.: US 2005/0275550 A1
(43) Pub. Date: Dec. 15, 2005

(54) Human-carrying vehicle and auxiliary device thereof

(76) Inventors: Ching-Sung Wang, Tu-Cheng City (TW); Yiu-Tong Chu, Taipei (TW); Tze-Ann Chen, Tu-Cheng City (TW); Ming-Chen Wu, Chung-Li City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/142,069

(22) Filed: May 31, 2005

(30) Foreign Application Priority Data
Jun. 11, 2004 (TW) 093116993

(51) Int. Cl. G08B 17/10

(52) U.S. Cl. 340/632; 340/438; 340/573.1; 340/576

(57) ABSTRACT

A human-transporting vehicle has a chamber, a gas collector, a detection circuit and a determination circuit for improving driving safety. The gas collector collects a gas sampling and the determination circuit determines whether a concentration of a certain composition in the gas sampling exceeds a predetermined value. If the determination result is positive, the determination circuit disables the vehicle so that the vehicle cannot start. An audio device and a display are utilized for providing the driver with information to know whether it is safe to drive the vehicle.

### BACKGROUND OF THE INVENTION

1. Field of Invention

The present invention relates to vehicles, particularly to vehicles having auxiliary devices for improving driving safety.

2. Description of Related Art

On Oct. 2, 2003, the Century Council released a nationwide survey, which revealed 66% of federal and state opinion leaders believe that fighting against hardcore drunk driving is an overwhelming priority. Hardcore drunk drivers are those who drive with a high blood alcohol concentration (BAC) of 0.15 or above, who do so repeatedly, as demonstrated by having more than one drunk driving arrest, and who are highly resistant to changing their behavior despite previous sanctions, treatment, or education efforts.

According to NATIONAL HARDCORE DRUNK DRIVER PROJECT, hardcore drunk drivers are responsible for 58% of alcohol-related traffic fatalities and are 380 times more likely to be involved in a crash. Drivers with BAC levels in excess of 0.15 are only one percent of all drivers on weekend nights; however, they are involved in nearly 50% of all fatal crashes during that time.

Nowadays, policemen and policewomen have to expose themselves in front of these drunk drivers on highways or country roads to find out the BAC level of these drunk drivers. However, this means policemen and policewomen endanger themselves when enforcing the law to prevent accidents that may be caused by these drunk drivers.

If drunk driving is so dangerous for drunk drivers, innocent public and even policemen and policewomen, it would be beneficial to bring a new design to prevent any automobile accident in advance.

### SUMMARY OF THE INVENTION

An objective of the present invention is to provide a car and an auxiliary device therein that prevent drunk driving in advance.

According to an embodiment of the present invention applied in a car, the car includes a chamber, a gas collector, a detection circuit and a determination circuit. The chamber is used for containing a driver to sit inside to drive the car. The gas collector is used for extracting a gas sampling in the chamber. The detection circuit is used for detecting a concentration of a certain composition in the gas sampling. The determination circuit is coupled to the detection circuit to prevent the car from being started if the concentration of the certain composition in the gas sampling exceeds a predetermined value.

With such mechanism, drunk driving is prevented in advance by locking the car when the blood alcohol concentration of the driver exceeds a predetermined value.

### BRIEF DESCRIPTION OF THE DRAWINGS

The accompanying drawings are included to provide further understanding of the invention, and constitute a part of this specification. The drawings illustrate the embodiments of the invention and, together with the description, serve to explain the principles of the invention. In the drawings,

FIG. 1 illustrates a car embodiment according to the present invention;

FIG. 2 illustrates a method for installing an auxiliary device in the car of FIG. 1;

FIG. 3 illustrates a front view of the auxiliary device;

FIG. 4 illustrates a back view of the auxiliary device; and

FIG. 5 illustrates a systematic diagram of the auxiliary device.

### DESCRIPTION OF PREFERRED EMBODIMENT

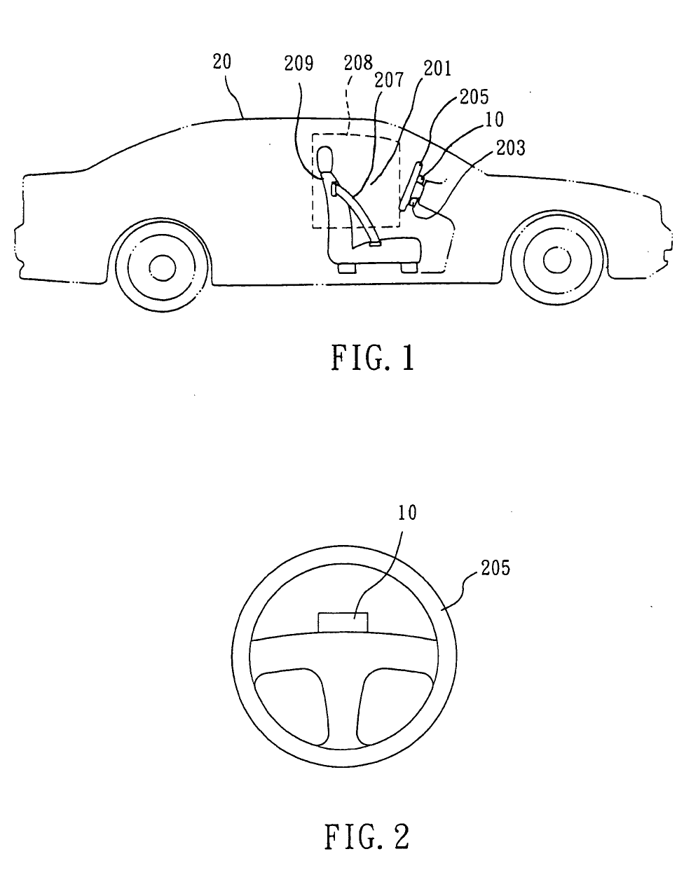

FIG. 1 illustrates a preferred embodiment according to the present invention, which includes a vehicle, i.e. a car 20, and an auxiliary device 10 thereon. The term vehicle includes all mechanical apparatuses that transport humans, e.g. cars, airplanes, and ships.

The car 20 has a chamber 201, starter device 203, a steering wheel 205, a safety belt device 207, a window 208 and a seat 209. In addition, the auxiliary device is disposed on the steering wheel 205.

FIG. 2 is a part-enlarged figure of FIG. 1, illustrating a method for installing the auxiliary device 10. In an example of implementing the auxiliary device 10, a housing is used for containing the elements of the auxiliary device 10 to make the auxiliary device 10 a module. With such implementation, the cost and complexity of re-engineering the car 20 can be decreased significantly.

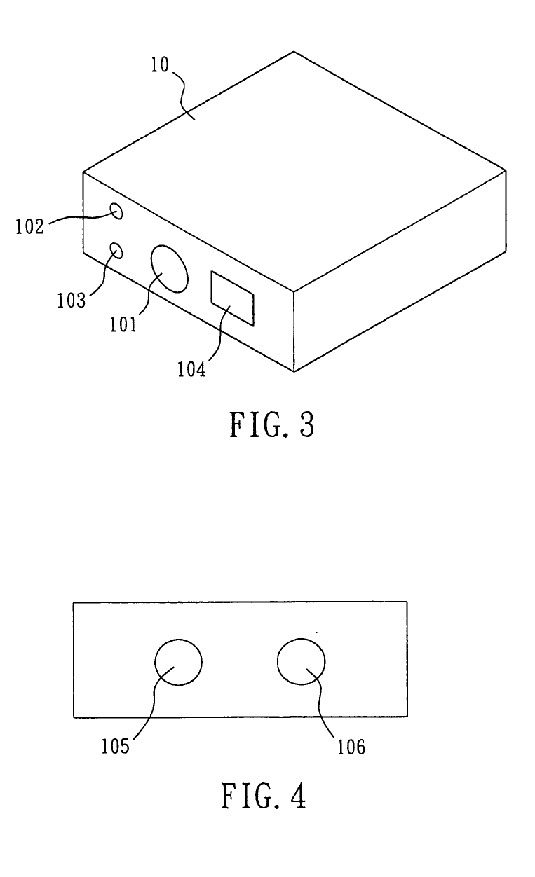

FIG. 3 and FIG. 4 separately illustrate a front view and a back view of the auxiliary device 10. In FIG. 3, the auxiliary device 10 has a blow entrance 101, an alarm indicator 102, a blow indicator 103 and a concentration indicator 104. In FIG. 4, the auxiliary device 10 has a power supply end 105 and a control output end 106.

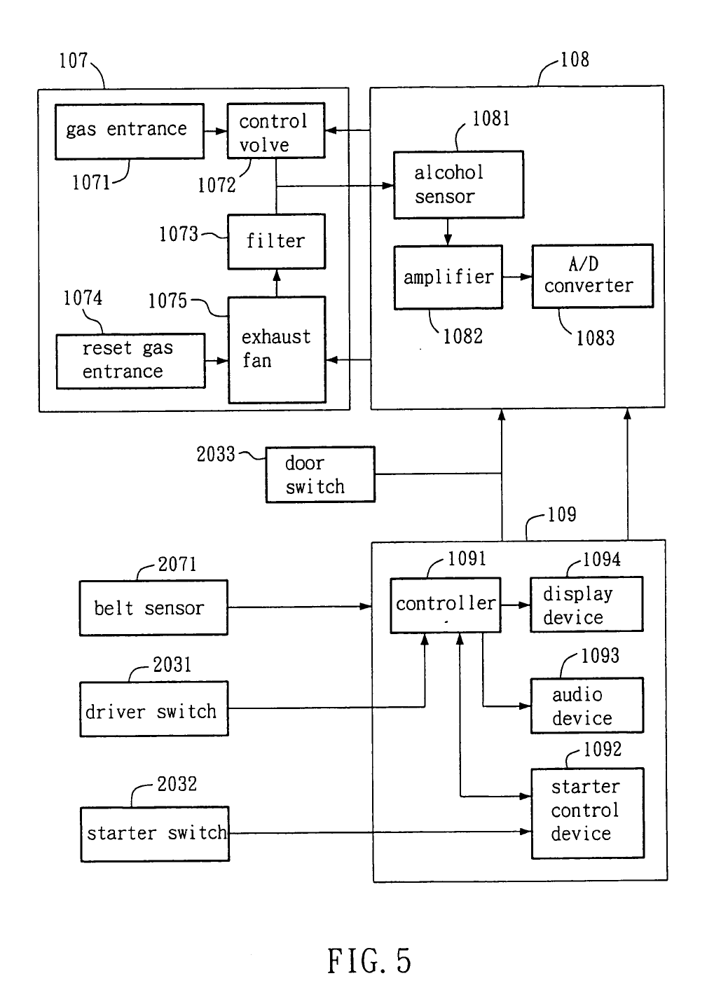

FIG. 5 illustrates a systematic diagram of the auxiliary device 10. In the illustrated example, the auxiliary device 10 has a gas collector 107, a detection circuit 108 and a determination circuit 109. Components of the gas collector 107 include a gas entrance 1071, a control valve 1072, a filter 1073, a reset gas entrance 1074 and an exhaust fan 1075. The filter 1073 is used for filtering reset gas for comparison. The control valve 1072 is used for controlling when a gas sampling is sent to the detection circuit 108.

With the control valve 1072 and the exhaust fan 1075, the gas sampling is transmitted via the gas entrance 1071 to the detection circuit 108. The detection circuit 108 has an alcohol sensor 1081, an amplifier 108 and an analog-to-digital (A/D) converter 1083. The alcohol sensor 1081 detects a concentration of alcohol composition in the gas sampling, and the detected result, e.g. a voltage or current value, is amplified by the amplifier 1082 and then transformed to a corresponding value by the A/D converter 1083.

The detected value is transmitted to the determination circuit 109. The determination circuit 109 has a controller 1091, a starter control device 1092, an audio device 1093 and a display device 1094. The controller 1091 receives the detected value from the detection circuit 108, and determines whether the detected value exceeds a predetermined value, e.g. 0.25 mg/l alcohol gas concentration. When an alcohol concentration of the driver is determined over the legal value, the controller 1091 sends a command to the starter switch 2032 to prevent the car from being started.

Besides, the controller 1091 also shows the detection result through the display device 1094. An example of the display device 1094 is the indicator 102 and the concentration indicator 104 in FIG. 3.

With the above device, drunk driving can be prevented in advance without exposing policemen or policewomen to danger as safe driving is ensured.

Moreover, to make the auxiliary device 10 more convenient, an additional sensor can be incorporated. For example, the safety belt sensor 2071 that is coupled to the safety belt device 207 can be used for determining whether the driver has used the safety belt device 207, and can be used for deciding when to start the alcohol detection mechanism as described above. Another approach to activate the alcohol detection mechanism is to couple a driver switch 2031 to the controller 1091. When the driver uses the driver switch 2031, the alcohol detection mechanism is activated. Also, the seat 209 in FIG. 1 can be equipped with a sensor to detect the pressure when the driver sits on the seat 209 for activating the alcohol detection mechanism.

To make the detection more precise, the window 208 in FIG. 1 or the door switch 2033 in FIG. 5 can be equipped with sensors coupled to the controller 1091. Such mechanism ensures the correctness of the detection result. Further, the window 208 can be closed until the detection procedure has finished.

Also, the gas collector 107 can be implemented to suck the gas sampling directly from the chamber 201 for detection. Alternatively, the gas collector 107 can be equipped with a blow entrance so that the driver blows into the gas entrance directly as the gas sampling.

To assist the driver to operate the above auxiliary device 10, an audio device 1093 can be used for providing the driver with corresponding messages via audio. For example, the audio device 1093 guides the driver to blow to the blow entrance or inform the driver that the detection result shows that the driver should not drive at that moment.

In addition to the alcohol detection, the system architecture described above can be used for detecting whether there is gas that may harm human health, e.g. CO₂ concentration. Even though a car is used for explaining the present invention, it is to be noted that such embodiment can be applied in other vehicles, like ships or airplanes.

Although the present invention is described using the above embodiments, it does not mean that the scope of the present invention is limited to the above description. Persons skilled in the art can make all kinds of modifications, for example, changing the selected polymeric material, introducing different conductive particles, changing electroplating conditions, changing constituent weight ratio, to achieve the same effects. However, these modifications shall not deviate from the spirit of the present invention, and they shall fall within the scope of protection of the present invention. The scope of protection of the present invention shall not be limited to the description of the claims.

1. A human-transporting vehicle for improving driving safety, comprising:
a chamber for containing a driver to sit inside to drive the vehicle;
a gas collector for extracting a gas sampling from the chamber;
a detection circuit for detecting a concentration of at least one certain composition in the gas sampling; and
a determination circuit coupled to the detection circuit for preventing the vehicle from being started if the concentration of the at least one preventing certain composition in the gas sampling exceeds a predetermined value.

2. The human-transporting vehicle of claim 1, further comprising a starter device coupled to the determination circuit for starting the vehicle.

3. The human-transporting vehicle of claim 2, wherein the gas collector, the detection circuit and the determination circuit are triggered for extracting the gas sampling and determining the concentration of the certain composition in the gas sampling when the driver activates the starter device.

4. The human-transporting vehicle of claim 1, further comprising a safety belt device, wherein the gas collector, the detection circuit and the determination circuit are triggered for extracting the gas sampling and determining the concentration of the certain composition in the gas sampling when the driver uses the safety belt device.

5. The human-transporting vehicle of claim 1, wherein the chamber has a seat sensor and the gas collector, the detection circuit and the determination circuit are triggered for extracting the gas sampling and determining the concentration of the certain composition in the gas sampling when the seat sensor detects the driver sitting in the chamber.

6. The human-transporting vehicle of claim 1, wherein the gas collector is placed in the chamber for collecting gas inside the chamber as the sampling gas.

7. The human-transporting vehicle of claim 1, wherein the gas collector has a blow entrance for the driver to blow so as to obtain the gas sampling.

8. The human-transporting vehicle of claim 7, further comprising an audio device installed in the chamber to inform the driver to blow the blow entrance.

9. The human-transporting vehicle of claim 8, wherein the audio device reminds the driver about whether it is suitable for driving.

10. The human-transporting vehicle of claim 8, further comprising a display coupled to the determination circuit for showing a determination result of the determination circuit.

11. The human-transporting vehicle of claim 1, wherein the chamber has at least one window and the window is closed until the determination circuit finishes the determination.

12. The human-transporting vehicle of claim 1, wherein the determination circuit checks whether the chamber is airtight to ensure the correctness of the determination of the determination circuit.

13. The human-transporting vehicle of claim 1, wherein the chamber contains a steering wheel and the gas collector is installed on the steering wheel.

14. The human-transporting vehicle of claim 1, wherein the certain composition comprises alcohol.

15. The human-transporting vehicle of claim 1, wherein the certain composition comprises human-harming gas.

16. The human-carrying vehicle of claim 1, wherein the vehicle is a car.

17. An auxiliary device for installed in a vehicle for improving driving safety, the vehicle having a chamber, the device comprising:
a gas collector for extracting a gas sampling of the chamber;
a detection circuit for detecting a concentration of at least one certain composition in the gas sampling; and
a determination circuit coupled to the detection circuit for stopping the vehicle to start if the concentration of the certain composition exceeds a predetermined value.

18. The auxiliary device of claim 17, wherein the vehicle further comprises a starter device coupled to the determination circuit for starting the vehicle and the determination circuit are triggered for extracting the gas sampling and determining the concentration of the certain composition in the gas sampling when the driver activates the starter device.

19. The auxiliary device of claim 17, wherein gas collector is installed in the chamber for sucking gas in the chamber as the sampling gas.

20. The auxiliary device of claim 17, wherein the gas collector comprises a blow entrance for the driver to blow to obtain the gas sampling.
